(19) United States
(12) Patent Application Publication
(10) Pub. No.: US 2011/0296803 A1
(43) Pub. Date: Dec. 8, 2011

(54) AIR FILTER CLEANER AND VIDEO PROJECTOR

(75) Inventors: Yosuke Nishihata, Hirakata-shi (JP); Akira Miyanaga, Daito-shi (JP); Yoshiharu Arioka, Osaka-shi (JP); Hideaki Okaniwa, Nagoya-shi (JP)

(73) Assignee: SANYO ELECTRIC CO., LTD, Osaka (JP)

(21) Appl. No.: 13/154,089

(22) Filed: Jun. 6, 2011

(30) Foreign Application Priority Data
Jun. 8, 2010 (JP) 2010-131296

(51) Int. Cl. B01D 50/00; B01D 46/42

(52) U.S. Cl. 55/295

(57) ABSTRACT

An air filter cleaner includes a brush, which cleans an air filter. A case moves back and forth together with the brush, which is arranged on the case. A pinion moves the brush and case back and forth and is arranged in the case. A rack supports the pinion. The rack is arranged along a direction in which the brush moves back and forth and includes a side surface facing toward the case. A groove, which is arranged in the side surface of the rack, extends in the direction in which the brush moves back and forth. A flange, which extends from the case, engages with and slides in the groove. The engagement of the groove and flange restricts movement of the case in a direction perpendicular to the direction in which the brush moves back and forth.

### CROSS-REFERENCE TO RELATED APPLICATIONS

This application is based upon and claims the benefit of priority from prior Japanese Patent Application No. 2010-131296, filed on Jun. 8, 2010, the entire contents of which are incorporated herein by reference.

### BACKGROUND OF THE INVENTION

The present invention relates to an air filter cleaner and to a video projector including the air filter cleaner.

A known air filter cleaner includes a brush that cleans an air filter. Japanese Laid-Open Patent Publication No. 2009-82837 describes an air filter cleaner including a rack, a pinion engaged with the rack, and a brush moved back and forth by the pinion in engagement with the rack.

Japanese Laid-Open Patent Publication No. 2007-156186 describes a video projector including an air filter cleaner.

### SUMMARY OF THE INVENTION

A video projector may be set in various positions, such as on the plane of a table, on the ceiling, or on a wall. When such a video projector is combined with the air filter cleaner described in the '837 publication, a change in the set position of the video projector relative to the gravitational direction may result in instable support of the brush in its case.

One aspect of the present invention is an air filter cleaner including a brush that cleans an air filter. A case moves back and forth together with the brush, which is arranged on the case. A moving mechanism moves the brush and the case back and forth. The moving mechanism is arranged on the case. A support supports the moving mechanism. The support is arranged along a direction in which the brush moves back and forth. The support includes a side surface facing toward the case. A first engagement portion is arranged on the side surface of the support. The first engagement portion is arranged along the direction in which the brush moves back and forth. A second engagement portion is arranged on the case. The second engagement portion engages with and slides relative to the first engagement portion of the support. The engagement of the first engagement portion and the second engagement portion restricts movement of the case in a direction perpendicular to the direction in which the brush moves back and forth.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1(a) and 1(b) are perspective views showing a video projector according to one embodiment of the present invention;

FIG. 2 is a schematic diagram of an optical system in the video projector of FIG. 1(a);

FIG. 3 is a side view showing the video projector of FIG. 2;

FIG. 4 is a perspective view showing an air filter cleaner of FIG. 1(a);

FIG. 5 is a plan view showing the air filter cleaner of FIG. 4;

FIG. 6 is an exploded perspective view showing the air filter cleaner of FIG. 4;

FIGS. 7(a) and 7(b) are perspective views showing a rack, partially in cross-section, of the air filter cleaner of FIG. 6;

FIG. 8 is an exploded perspective view showing a cleaning unit arranged in the air filter cleaner of FIG. 6;

FIGS. 9(a) and 9(b) are perspective views showing a case of the cleaning unit of FIG. 8;

FIG. 10 is a perspective view showing a dust box, in an open state, arranged in the cleaning unit of FIG. 6;

FIGS. 11 and 12 are cross-sectional views showing a rack that supports the case in the cleaning unit of FIG. 6;

FIG. 13 is a schematic diagram showing the dimensions of the case and racks;

FIG. 14 is a perspective view showing a video projector set on a horizontal surface;

FIG. 15 is a cross-sectional view showing the case and racks in correspondence with the video projector of FIG. 14;

FIG. 16 is a perspective view showing the video projector set on a ceiling;

FIG. 17 is a cross-sectional view showing the case and racks in correspondence with the video projector of FIG. 16;

FIG. 18 is a perspective view showing the video projector set in an upwardly oriented state;

FIG. 19 is a cross-sectional view showing the case and racks in correspondence with the video projector of FIG. 18;

FIG. 20 is a perspective view showing the video projector set in a downwardly oriented state; and

FIG. 21 is a cross-sectional view showing the case and racks in correspondence with the video projector of FIG. 20.

### DETAILED DESCRIPTION OF THE INVENTION

A projector 1 according to one embodiment of the present invention will now be discussed with reference to the drawings.

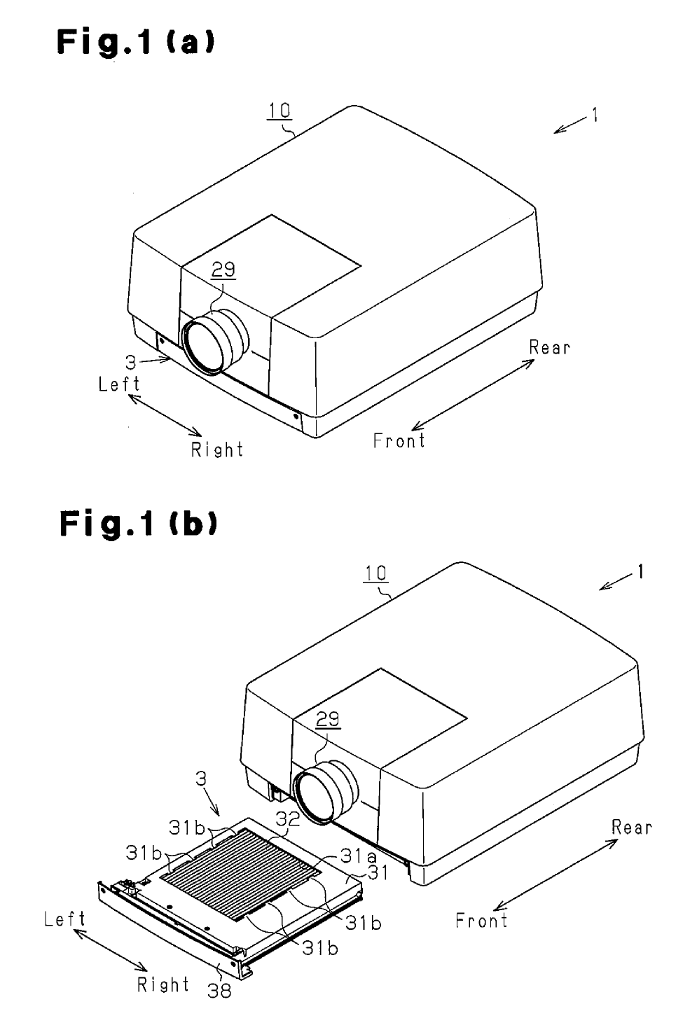

FIG. 1 shows the projector 1 arranged in a horizontal state. The projector 1 projects image light toward the front from a projection lens 29 to display an image. The projector 1 includes an outer case 10, or a frame, which accommodates electronic components and optical components. The outer case 10 includes a front surface, a rear surface, a right surface, a left surface, an upper surface, and a lower surface. In the description hereafter, unless otherwise indicated, the upper, lower, left, right, front, and rear directions are as indicated by the arrows shown in FIG. 1.

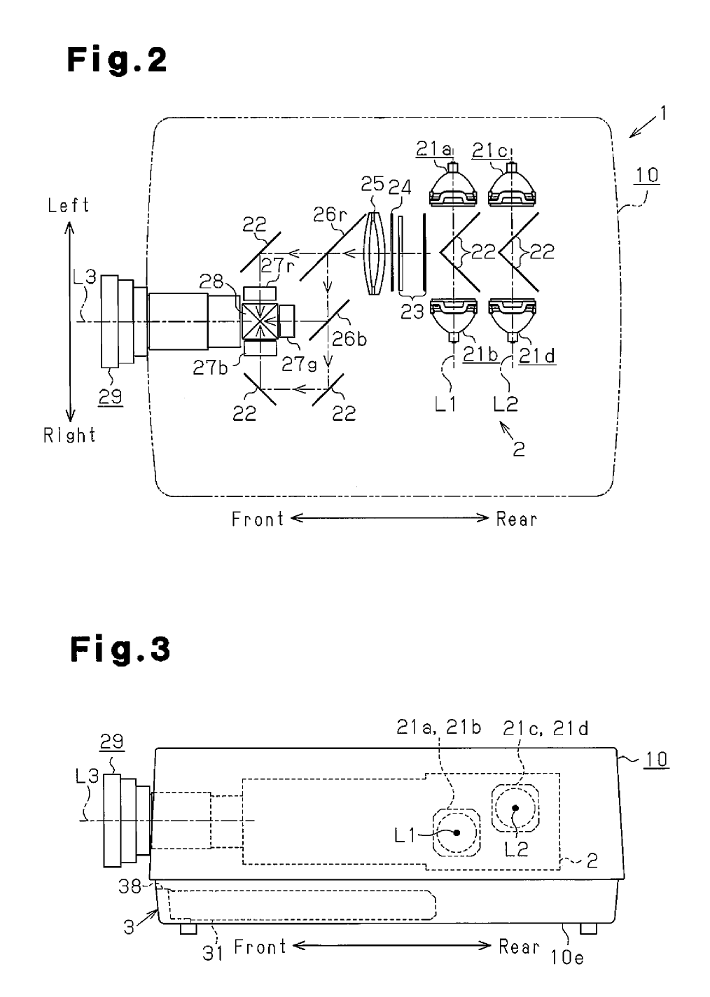

As shown in FIGS. 2 and 3, the projector 1 includes an optical system 2. The optical system 2 includes optical components, such as lamps 21a, 21b, 21c, and 21d, dichroic mirrors 26r and 26b, liquid crystal light valves 27r, 27g, and 27b, a cross-dichroic prism 28, and the projection lens 29. The lamps 21a, 21b, 21c, and 21d serve as a light source for displaying an image. The dichroic mirrors 26r and 26b separate white light into the three primary colors of light, namely, red light, green light, and blue light. The liquid crystal light valves 27r, 27g, and 27b respectively correspond to the three primary colors of light.

The lamps 21a, 21b, 21c, and 21d each emit white light as collimated light. Further, the lamps 21a, 21b, 21c, and 21d may each be formed by a discharge lamp, such as an ultrahigh pressure mercury lamp or metal halide lamp. The lamp 21a has an optical axis L1 aligned with that of the lamp 21b. The lamp 21c has an optical axis L1 aligned with that of the lamp 21d. In the illustrated example, the optical axes of the lamps 21a, 21b, 21c, and 21d are parallel to each other.

The lamps 21a, 21b, 21c, and 21d are arranged so that the height of the optical axis L1 differs from that of the optical axis L2. In the example of FIG. 3, the lamps 21a and 21b are closer to the lower surface 10e of the outer case 10 than the lamps 21c and 12d.

The light emitted from the lamps 21a, 21b, 21c, and 21d is reflected by corresponding full-reflection mirrors 22 and guided via an integrator lens 23, a polarizing beam splitter 24, and a condenser lens 25 to the liquid crystal light valves 27r, 27g, and 27b. The integrator lens 23 includes two fly's eye lens and realizes uniform illuminance distribution. The polarizing beam splitter 24 set the polarization direction in a predetermined direction. The condenser lens 25 condenses the light that enters the liquid crystal light valves 27r, 27g, and 27b.

The dichroic mirror 26r, which transmits red light, and the dichroic mirror 26b, which transmits blue light, separates the white light emitted from the lamps 21a, 21b, 21c, and 21d into red light, green light, and blue light.

The red light enters the liquid crystal light valve 27r. The green light enters the liquid crystal light valve 27g. The blue light enters the liquid crystal light valve 27b. The liquid crystal light valves 27r, 27g, and 27b are light valves that vary the transmission rate of light for each pixel. Transmission of the red light, green light, and blue light through the corresponding liquid crystal light valves 27r, 27g, and 27b generate a red image, green image, and blue image.

The cross-dichroic prism 28 combines the light of the red, green, and blue images, which are generated by the liquid crystal light valves 27r, 27g, and 27b, to generate a full-color image. The projection lens 29 projects the light of the image. In this manner, the projector 1 displays the image on a flat surface arranged in front of the projector 1, such as a screen or a wall. As shown in FIG. 2, the optical axis L3 of the projection lens 29 is orthogonal to the optical axes L1 and L2.

To prolong the life of the lamps 21a, 21b, 21c, and 21d, which generate heat when emitting light, the lamps 21a, 21b, 21c, and 21d must be arranged so that their optical axes L1 and L2 are not oriented in the vertical direction. In the present embodiment, the optical axes L1 and L2 are orthogonal to the optical axis L3. Thus, the direction of the projection lens 29 (optical axis L3) may be changed while keeping the optical axes L1 and L2 horizontal. For example, the projector 1 may be arranged so that its lower surface 10e faces toward a horizontal surface or ceiling to display an image on a screen or wall. The projector 1 may also be arranged so that its lower surface 10e faces toward a wall to display an image on the floor or ceiling.

The illustrated projector 1 is a four-lamp, three-LCD projector. In addition to the optical components described above, the outer case 10 accommodates electronic components (not shown), which drive liquid crystal panels of the liquid crystal light valves 27r, 27g, and 27b, and an intake fan, which cools the optical components and electronic components. The intake fan is driven to draw air into the outer case 10.

The projector 1 includes an air filter device 3 (refer to FIG. 1). The air filter device 3 captures dust from the air entering the outer case 10. In the description hereafter, the direction oriented toward the interior of the outer case 10 will be referred to as an inward or downstream direction.

As shown in FIG. 1(a), the air filter device 3 is coupled to a lower portion of the outer case 10. The air filter device 3 is drawn out from the front of the outer case 10 for removal from the projector 1. To couple the air filter device 3 to the projector 1, the air filter device 3 is pushed rearward into the outer case 10.

The air filter device 3 includes a base 31, which is formed from a resin material. The base 31 includes a tetragonal opening 31a, which serves as an air inlet. An electrostatic filter 32 is arranged on the base 31 to cover the opening 31a. The opening 31a is further covered by a urethane filter (not shown). The urethane filter is an air filter formed from urethane.

The electrostatic filter 32 is an air filter formed from electrostatic fibers. The electrostatic filter 32 may include a corrugated filter element. The electrostatic filter 32 and urethane filter are elastically deformable. For example, the edges of the electrostatic filter 32 and urethane filter are elastically compressed and embedded in the base 31. Tabs 31b are formed integrally with the base 31 to prevent separation and displacement of the electrostatic filter 32 and urethane filter.

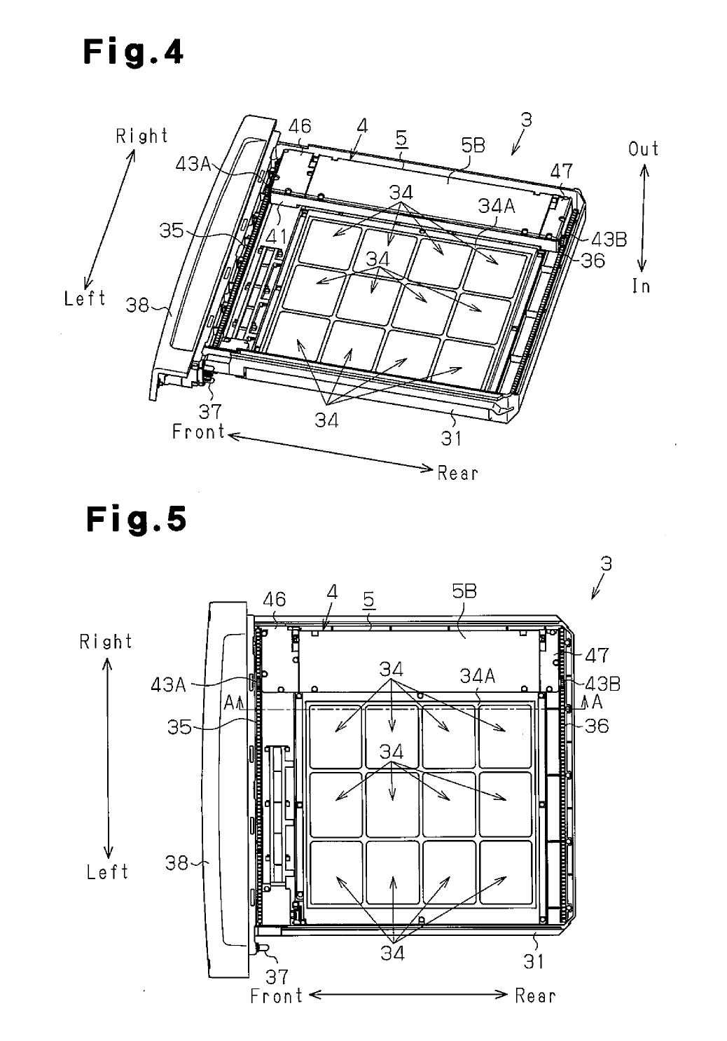

The structure at the outer side of the air filter device 3 will now be described with reference to FIGS. 4 and 5. The air filter device 3 includes an air filter 34, which is arranged outward from the electrostatic filter 32 and urethane filter. The air filter 34 is adhered or fused to a grid 34A. The grid 34A is fastened by screws to the base 31.

Linear first and second racks 35 and 36 are fastened to the base 31. The first rack 35 is fixed to the grid 34A at a location frontward from the air filter 34. The second rack 36 is fixed to the grid 34A at a location rearward from the air filter 34. The racks 35 and 36 are parallel to each other and arranged on opposite sides of the air filter 34.

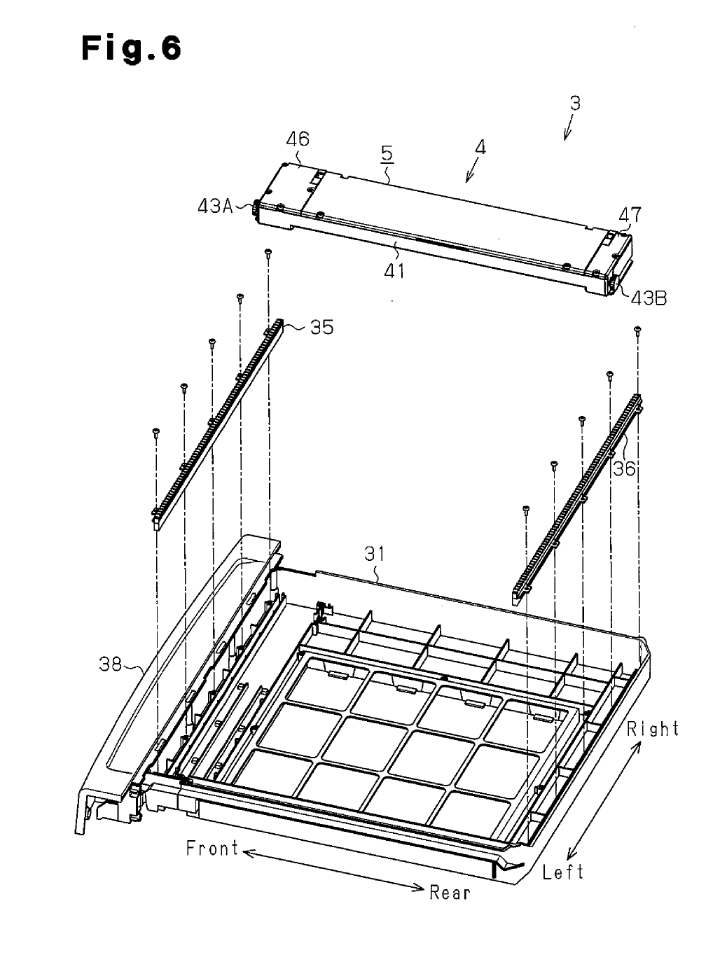

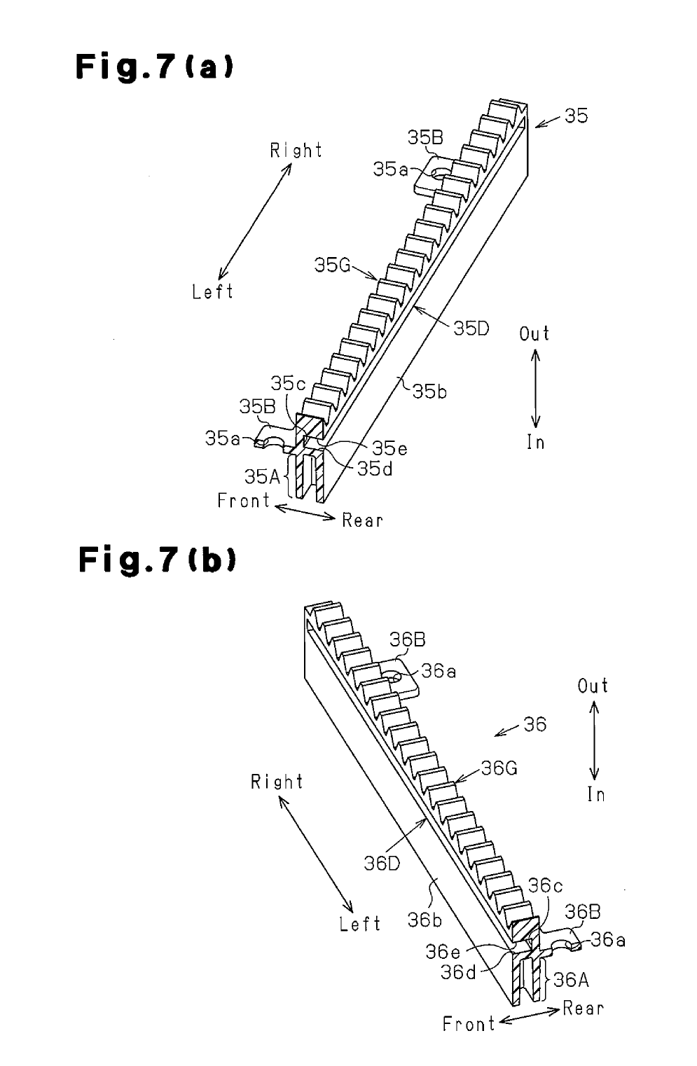

Referring to FIG. 6, the racks 35 and 36 are fastened by screws to the base 31. FIGS. 7(a) and 7(b) show the racks in cross-section taken along line A-A in FIG. 5.

As shown in FIG. 7(a), the first rack 35 includes an insertion portion 35A, which is fitted into the base 31, a plurality of fastened portions 35B, which include holes 35a, and teeth 35G. The teeth 35G are arranged along the longitudinal axis of the first rack 35.

The insertion portion 35A extends along the longitudinal axis of the first rack 35 and projects inward. To reduce manufacturing costs, the insertion portion 35A may be hollow. Each fastened portion 35B extends toward the front. In a state in which the insertion portions 35A are inserted into the first rack 35, a screw is fitted into the hole 35a of each fastened portion 35B to fasten the first rack 35 to the base 31.

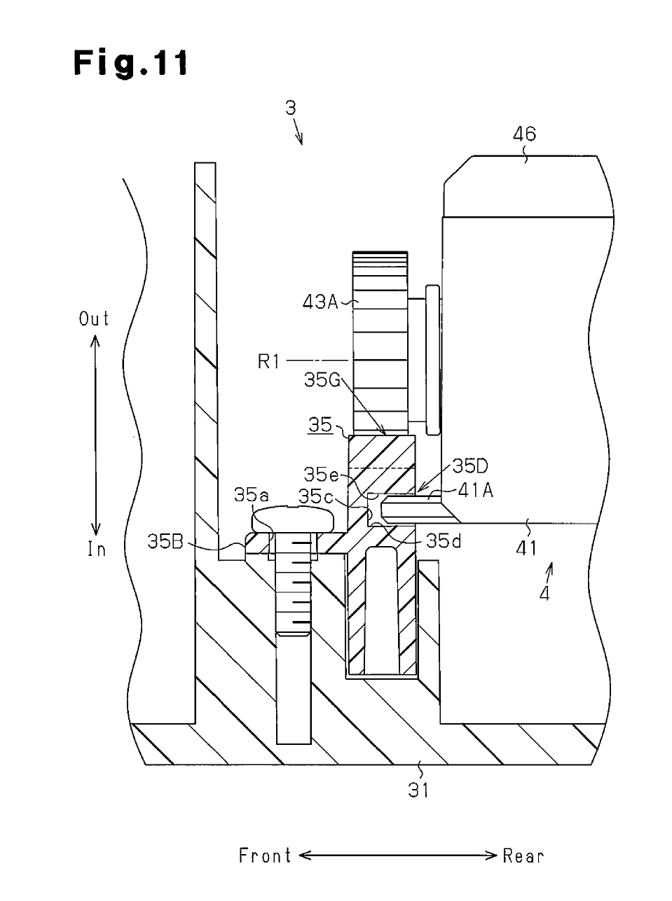

The first rack 35 includes a rear side surface 35b. A groove 35D extends in the rear side surface 35b along the longitudinal axis of the first rack 35. The groove 35D is shaped to have a uniform cross-section. As shown in FIGS. 7(a) and 11, the groove 35D includes a first inner surface 35c, a second inner surface 35d, and a third inner surface 35e. The first inner surface 35c is defined by the front of the groove 35D. The second and third inner surfaces 35d and 35e are parallel to each other and connect the first inner surface 35c with a rear side surface 35b.

As shown in FIG. 7(b), the second rack 36 includes an insertion portion 36A, which is fitted into the base 31, a plurality of fastened portions 36B, which include holes 36a, and teeth 36G. The teeth 36G are arranged along the longitudinal axis of the second rack 36.

The insertion portion 36A extends along the longitudinal axis of the second rack 36 and projects inward. To reduce manufacturing costs, the insertion portion 36A may be hollow. The second rack 36 is fastened to the base 31 in the same manner as the first rack 35.

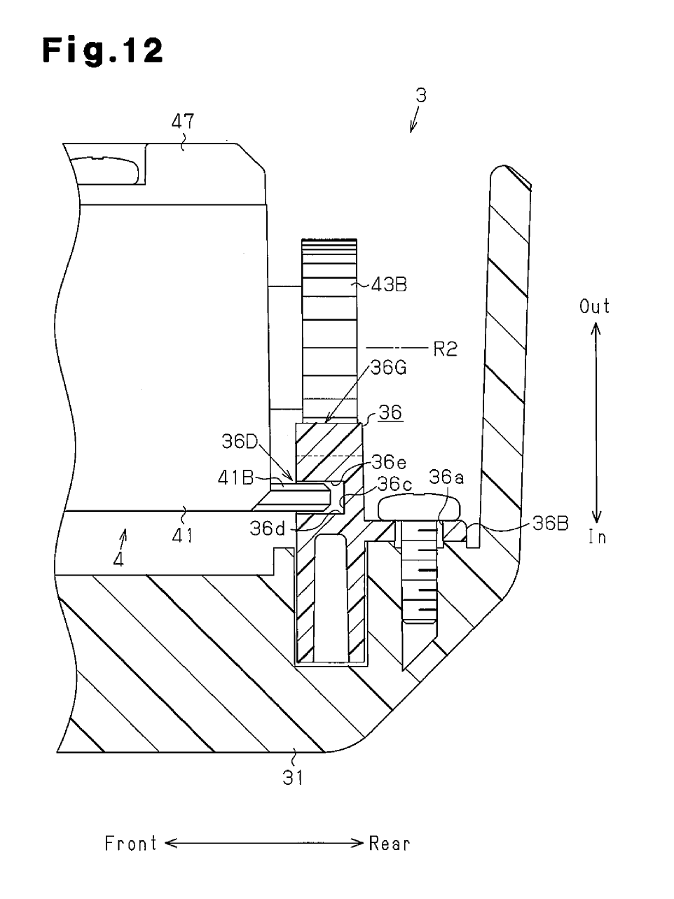

The second rack 36 includes a front side surface 36b. A groove 36D extends in the front side surface 36b along the longitudinal axis of the second rack 36. The groove 36D is shaped to have a uniform cross-section. As shown in FIGS. 7(b) and 12, the groove 36D includes a first inner surface 36c, a second inner surface 36d, and a third inner surface 36e. The first inner surface 36c is defined by the rear of the groove 36D. The second and third inner surfaces 36d and 36e are parallel to each other and connect the first inner surface 36c with a front side surface 36b.

In the illustrated example, the groove 35D is arranged at a height that differs from that of the fastened portions 35B. This ensures mechanical strength for the first rack 35 when molded from resin and facilitates formation of the first rack 35 with the desired dimensions. The same applies for the second rack 36.

As shown in FIGS. 4 and 5, a connector 37 of the air filter device 3 is arranged on a front part of the base 31. When the air filter device 3 is coupled to the projector 1, the connector 37 is connected to a connector (not shown) of the projector 1. Connection of the connector 37 with the connector of the projector 1 allows for power to be supplied from the projector 1 to the electrical components of the air filter device 3.

A panel 38 is coupled to the front of the base 31. The panel 38 is flush with the outer surface of the outer case 10 when the air filter device 3 is coupled to the projector 1.

When the air filter device 3 is coupled to the projector 1, a triple-layer air filter, which is formed by the electrostatic filter 32, the urethane filter, and the air filter 34, covers the opening 31a. The electrostatic filter 32 and the urethane filter may each be referred to as an inner filter. The air filter 34 may be referred to as an outer filter.

The air filter device 3 includes a cleaning unit 4, which automatically cleans the air filter 34. The air filter device 3 may be referred to as an air filter cleaner. The cleaning unit 4 is, for example, generally box-shaped. When the cleaning unit 4 is not cleaning the air filter 34, the cleaning unit 4 is separated from the air filter 34 and located at a non-cleaning position.

As shown in FIGS. 4 to 6, the racks 35 and 36 support the cleaning unit 4. As shown in FIG. 6, in a state in which the racks 35 and 36 are removed from the base 31, the cleaning unit 4 is removable from the racks 35 and 36.

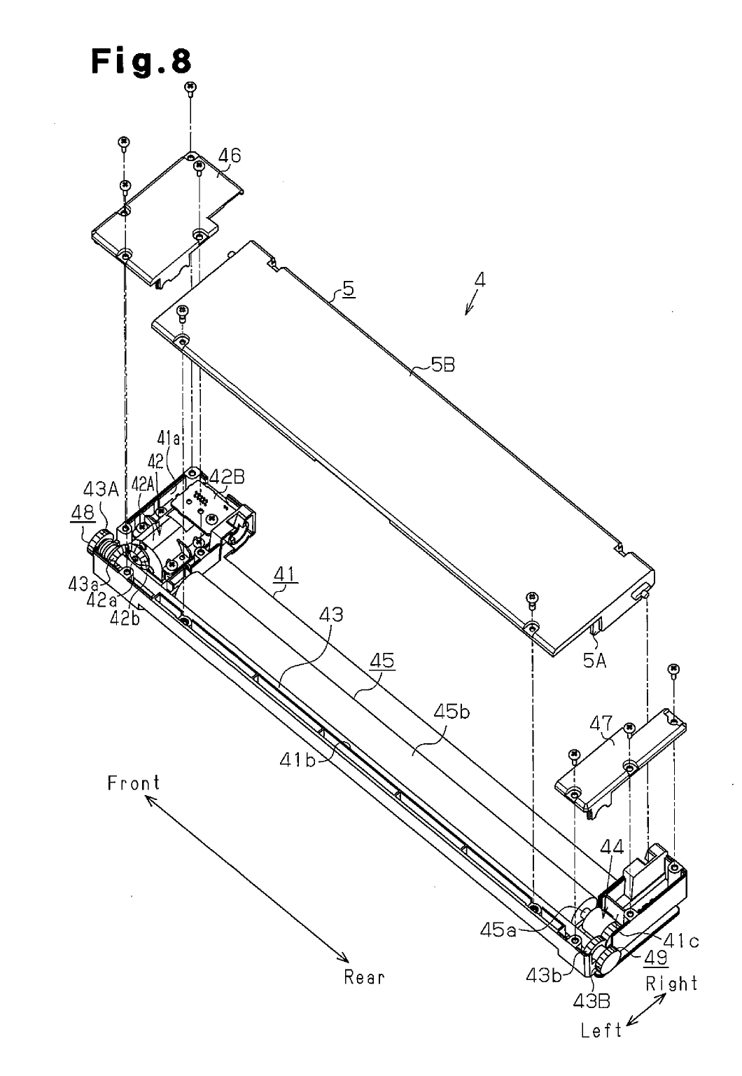

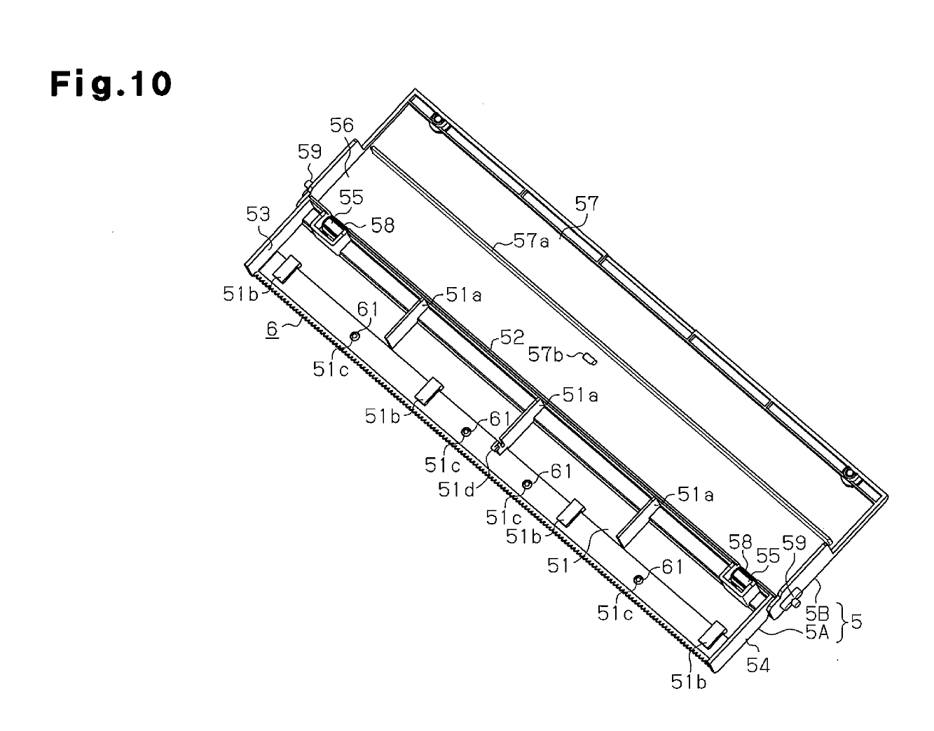

As shown in FIG. 8, the cleaning unit 4 includes a case 41, covers 46 and 47, a brush 45, a dust box 5, and a dust remover 6 (refer to FIG. 10). The covers 46 and 47 are fastened by screws to the case 41. The brush 45 cleans the air filter 34. The dust box 5 collects dust from the brush 45. The dust remover 6 removes dust from the brush 45.

The case 41 is formed from a resin material. In the illustrated example, the case 41 is formed from an acrylonitrile-butadiene-styrene (ABS) resin. A motor compartment 41a is arranged in the front part of the case 41. A motor 42 is accommodated in the motor compartment 41a. A rotary shaft compartment 41b is arranged in the left part of the case 41 extending from the front part to the rear part of the case 41. The rotary shaft compartment 41b accommodates a rotary shaft 43, which is rotated by the motor 42.

A power transmission mechanism compartment 41c is arranged at the rear part of the case 41. The power transmission mechanism compartment 41c accommodates a power transmission mechanism 44, which transmits the rotation of the rotary shaft 43 to the brush 45. The brush 45 and the dust box 5 are arranged in the right part of the case 41 surrounded by the motor compartment 41a at the front, the power transmission mechanism compartment 41c at the rear, and the rotary shaft compartment 41b at the left.

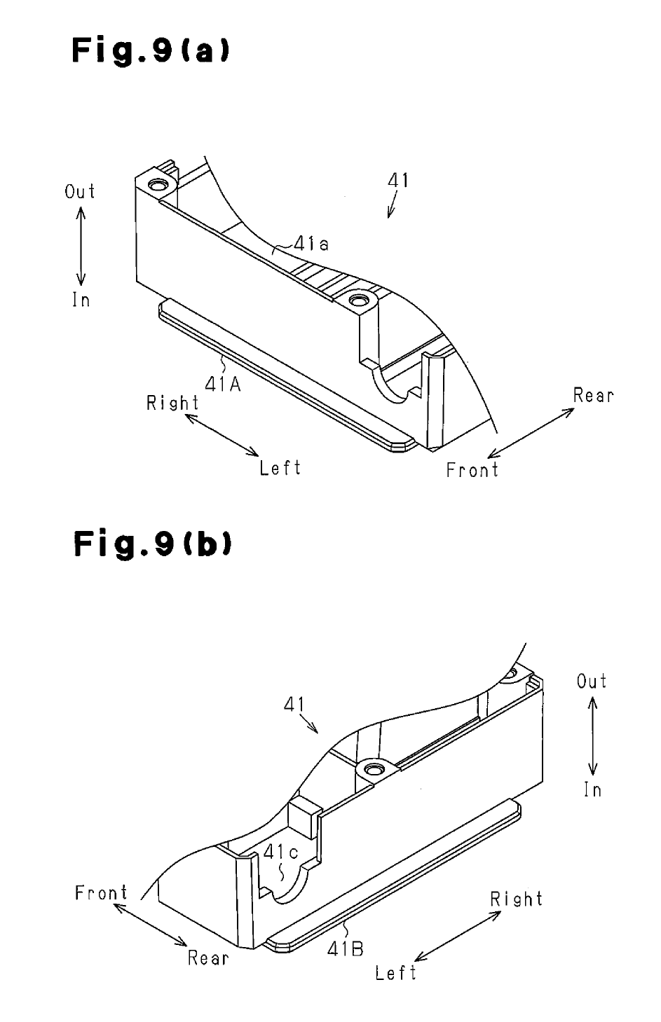

The case 41, which moves with the brush 45, includes extensions, or flanges 41A and 41B. As shown in FIG. 9(a), the flange 41A, which extends frontward from the case 41, is a plate elongated in the movement direction of the case 41. As shown in FIG. 9(b), the flange 41B, which extends rearward from the case 41, is a plate elongated in the movement direction of the case 41.

The flanges 41A and 41B are formed on the inward edges of the case 41. The flanges 41A and 41B are fitted into the grooves 35D and 36D in the side surfaces 35b and 36b of the racks 35 and 36, respectively. The flanges 41A and 41B are formed integrally with the case 41 from the same material. The flanges 41A and 41B may be chamfered.

The motor 42 is the power source of the cleaning unit 4. A motor cover 42A (refer to FIG. 6) is fastened by screws to the case 41 to cover the motor 42. The motor 42 includes an output shaft 42a. A bevel gear 42b is arranged on the output shaft 42a. The motor 42 rotates the bevel gear 42b when supplied with power via the connector 37 from the projector 1. In the illustrated example, the output shaft 42a of the motor 42 extends leftward. The bevel gear 42b is arranged in the rotary shaft compartment 41b.

A printed wiring board 42B (refer to FIG. 6) is accommodated in the motor compartment 41a. Power supply wires for the motor 42 are laid out on the printed wiring board 42B. The motor 42 moves integrally with the case 41. It is thus preferable that the motor 42 be connected to the connector 37, which is arranged on the base 31, by the printed wiring board 42B and a film-like flexible cable (not shown).

As shown in FIG. 8, a bevel gear 43a, which is engaged with the bevel gear 42b, is arranged on a front end of the rotary shaft 43. A spur gear 43b, which is connected to the power transmission mechanism 44, is arranged on a rear end of the rotary shaft 43. The motor 42 rotates the rotary shaft 43 with the bevel gears 42b and 43a. The spur gear 43b of the rotary shaft 43 transmits the rotation of the rotary shaft 43 to the power transmission mechanism 44. The rotary shaft 43 may be formed from a metal material.

A first pinion 43A is arranged on the front end of the rotary shaft 43. A second pinion 43B is arranged on the rear end of the rotary shaft 43. The pinions 43A and 43B may be formed from a resin material. The first pinion 43A projects frontward from the case 41. The second pinion 43B projects rearward from the case 41. The first and second pinions 43A and 43B are respectively engaged with the first and second racks 35 and 36. When the motor 42 generates rotation, the engagement of the racks 35 and 36 with the pinions 43A and 43B move the cleaning unit 4 leftward and rightward.

The bevel gear 43a and the first pinion 43A may be formed as a single resin member 48 that has superior sliding characteristics. The spur gear 43b and the second pinion 43B may also be formed as a single resin member 49 that has superior sliding characteristics. An intermediate collar between the bevel gear 43a and the first pinion 43A is supported by the front end of the case 41. An intermediate collar between the spur gear 43b and the second pinion 43B is supported by the front end of the case 41. In this manner, the case 41 supports the rotary shaft 43 in a rotatable manner. Further, the rotary shaft 43 is supported by portions other than the front and rear ends of the case 41.

The pinions 43A and 43B are arranged outside the case 41 and serve as moving mechanisms that move the brush 45 and the case 41 back and forth. The racks 35 and 36 are arranged in the reciprocating direction of the brush 45 and respectively engage with the pinions 43A and 43B. The racks 35 and 36 serve as supports that support the pinions 43A and 43B, respectively. In the illustrated example, the racks 35 and 36 are formed from a material that differs from that of the outer case 10. The racks 35 and 36 may be formed integrally with the outer case 10.

The power transmission mechanism 44 includes a mechanical element engaged with the spur gear 43b. The power transmission mechanism 44 is connected to a shaft 45a of the brush 45 to transmit torque from the rotary shaft 43 to the brush shaft 45a. When the rotary shaft 43 of the motor 42 is rotated, the brush 45 is rotated. It is preferable that the power transmission mechanism 44 be a one-way clutch that rotates the brush 45 only in the direction that collects dust in the dust box 5.

The brush 45 includes the shaft 45a, which is formed from a metal or resin material, and fibers, or bristles 45b, which extend radially outward from the shaft 45a. The case 41 supports the front and rear ends of the shaft 45a so that the brush 45 is rotatable. The bristles 45b have uniform distal ends so that the brush 45 has a cylindrical contour. The distal ends of some of the bristles 45b extend out of the case 41 in an inward direction of the outer case 10. Accordingly, when the cleaning unit 4 moves facing toward the air filter 34, the brush 45 contacts the outer surface of the air filter 34 so that the bristles 45b of the brush 45 remove dust from the air filter 34. This cleans the air filter 34. The dust on the rotating brush 45 is transferred into the dust box 5.

As shown in FIG. 8, the cover 46 covers the motor 42, printed wiring board 42B, and bevel gears 42b and 43a. The case 41 and the cover 46 hold the front ends of the rotary shaft 43 and the brush shaft 45a in a rotatable manner.

The cover 47 covers the spur gear 43b and the power transmission mechanism 44. By fastening the cover 47 to the case 41, the case 41 and the cover 47 hold the rear ends of the rotary shaft 43 and the brush shaft 45a in a rotatable manner. In this manner, the case 41 and the covers 46 and 47 function as bearings of the rotary shaft 43 and the brush shaft 45a.

Referring to FIG. 10, the dust box 5 has a longitudinal axis and is removable from the case 41. The dust box 5 is separable into an inner case 5A and an outer case 5B. In the illustrated example, the cases 5A and 5B are formed from a resin material. The cases 5A and 5B are pivotally coupled to each other to allow for the dust box 5 to open.

The inner case 5A includes an inner wall 51, a right wall 52, a front wall 53, and a rear wall 54. The inner case 5A includes rods 55, which pivotally couple the cases 5A and 5B.

The inner wall 51 has an outer surface that defines a downstream surface of the dust box 5. Partitions 51a extend from the inner wall 51 to partition the interior of the dust box 5. The partitions 51a prevent dust from being concentrated at the same location in the dust box 5.

The dust remover 6 is arranged on the inner wall 51 to remove dust from the bristles 45b of the brush 45. Clips 51b and projections 51c are formed integrally with the inner wall 51 to couple the dust remover 6 to the inner wall 51. The projections 51c are fitted into holes 61 of the dust remover 6. The clips 51b restrict movement of the dust remover 6.

The right wall 52 extends outward from the right end of the inner wall 51. The front wall 53 extends outward from the front end of the inner wall 51. The rear wall 54 extends outward from the rear end of the inner wall 51.

The rods 55 are arranged in the front and rear ends of the right wall 52. The rods 55 are, for example, cylindrical.

The outer case 5B includes an outer wall 56. The outer case 5B includes a brush cover 57, which covers the brush 45, rod supports 58, which pivotally support the cases 5A and 5B, and joints 59, which pivotally couple the dust box 5 to the case 41.

The outer wall 56 includes an outer surface, which is located at the downstream side of the dust box 5. Further, the outer wall 56 includes an inner surface along which a partition 57a extends in the longitudinal direction of the dust box 5. The partition 57a prevents dust from escaping the dust box 5.

A tongue 57b is arranged on the inner surface of the outer wall 56. When the dust box 5 is closed, the tongue 57b engages with an extension 51d, which is arranged on the distal end of one of the partitions 51a in the inner case 5A. Engagement of the tongue 57b with the extension 51d restricts pivoting of the outer case 5B relative to the inner case 5A and keeps the dust box 5 closed.

A brush cover 57 extends leftward from the outer wall 56. When the dust box 5 is coupled to the case 41, the brush cover 57 covers the rotary shaft 43 and the brush 45, which are arranged in the case 41. In the illustrated example, the brush cover 57 of the dust box 5 is fastened by screws to the case 41 to couple the dust box 5 to the case 41.

The rod supports 58 of the outer case 5B support the rods 55 of the inner case 5A. This pivotally couples the cases 5a and 5B to each other.

The joints 59 are arranged on the front and rear ends of the outer case 5B. Each joint 59 includes an elliptical projection and a cylindrical boss projecting outward from the boss. The case 41 supports the joints 59 when the dust box 5 is coupled to the case 41.

The dust box 5 is formed by the inner wall 51, the right wall 52, the front wall 53, and the rear wall 54. Further, the dust box 5 includes an elongated opening at the left side. Accordingly, when the dust box 5 is coupled to the case 41, the dust box 5 is open toward and parallel to the brush 45. The opening of the dust box 5 is formed to facilitate the collection of dust from the bristles 45b of the brush 45.

The dust box 5 is open in a direction that is the same as the direction in which the optical axes L1 and L2 of the lamps 21a, 21b, 21c, and 21d extend. Thus, when the optical axes L1 and L2 are horizontal, the longitudinal axis of the opening in the dust box 5 is horizontal. In this state, subtle dust escapes the dust box 5.

The dust remover 6 is coupled to the dust box 5. For example, the dust remover 6 is arranged on the left end of the inner case 5A. When the dust box 5 is coupled to the case 41, the edge of the dust remover 6 is arranged to card the bristles 45b of the brush 45. The dust remover 6 includes a surface 62, which faces toward the interior of the dust box 5. Rotation of the brush 45 removes dust from the bristles 45b of the brush 45 with the dust remover 6. The edge of the dust remover 6 may be saw-toothed. In such a case, the dust remover 6 effectively removes dust from the brush 45.

A feature of the present embodiment is in the grooves 35D and 36D of the racks 35 and 36 and the flanges 41A and 41B of the case 41.

The flange 41A of the case 41 is fitted into the groove 35D of the first rack 35. When the case 41 moves, the flange 41A slides in the groove 35D. More specifically, the flange 41A is slidable along the three inner surfaces 35c, 35d, and 35e of the groove 35D. Here, engagement or planar contact of the groove 35D with the flange 41A restricts movement of the case 41 in directions perpendicular to the longitudinal direction of the rack 35. The first rack 35 supports the flange 41A to restrict movement of the front of the case 41 only in the longitudinal direction of the rack 35.

In the same manner, the flange 41B of the case 41 is fitted into the groove 36D of the second rack 36. When the case 41 moves, the flange 41B slides in the groove 36D. More specifically, the flange 41B is slidable along the three inner surfaces 36c, 36d, and 36e of the groove 36D. Here, engagement or planar contact of the groove 36D with the flange 41B restricts movement of the case 41 in directions perpendicular to the longitudinal direction of the rack 36. The second rack 36 supports the flange 41B to restrict movement of the rear of the case 41 only in the longitudinal direction of the rack 36. The grooves 35D and 36D are referred to as first engagement portions. The flanges 41A and 41B are referred to as second engagement portions.

Referring to FIGS. 11 and 12, a structure for supporting the case 41 of the cleaning unit 4 with the racks 35 and 36 will now be described in detail. FIGS. 11 and 12 are cross-sectional diagrams taken along line A-A in FIG. 5.

In a state in which the pinions 43A and 43B are respectively engaged with the racks 35 and 36, the flanges 41A and 41B are respectively fitted into the grooves 35D and 36D. The racks 35 and 36 are fastened by screws to the base 31.

The first inner surfaces 35c and 36c of the grooves 35D and 36D are orthogonal to the longitudinal direction of the case 41 (refer to FIG. 11). More specifically, the first inner surface 35c of the groove 35D is orthogonal to a rotation axis R1 of the first pinion 43A (refer to FIG. 11). Further, the first inner surface 36c of the groove 36D is orthogonal to a rotation axis R2 of the second pinion 43B (refer to FIG. 11). In the present embodiment, the rotation axes R1 and R2 are in alignment with each other and not deviated from each other. The second inner surface 35d and third inner surface 35e are orthogonal to the first inner surface 35c. The second inner surface 36d and third inner surface 36e are orthogonal to the first inner surface 36c.

The rotation axes R1 and R2 are parallel to the filtering surface of the air filter 34, which is cleaned by the brush 45. The second and third inner surfaces 35d and 35e of the groove 35D and the second and third inner surfaces 36d and 36e of the groove 36D are orthogonal to the filtering surface of the air filter 34. The second and third inner surfaces 35d and 35e of the groove 35D face toward each other. The second and third inner surfaces 36d and 36e of the groove 36D face toward each other.

When the flange 41A is fitted into the groove 35D, the gap between the second inner surface 35d or third inner surface 35e and the flange 41 is smaller than the gap between the flange 41A and the first inner surface 35c. Further, when the flange 41B is fitted into the groove 36D, the gap between the second inner surface 36d or third inner surface 36e and the flange 41B is smaller than the gap between the flange 41B and the first inner surface 36c.

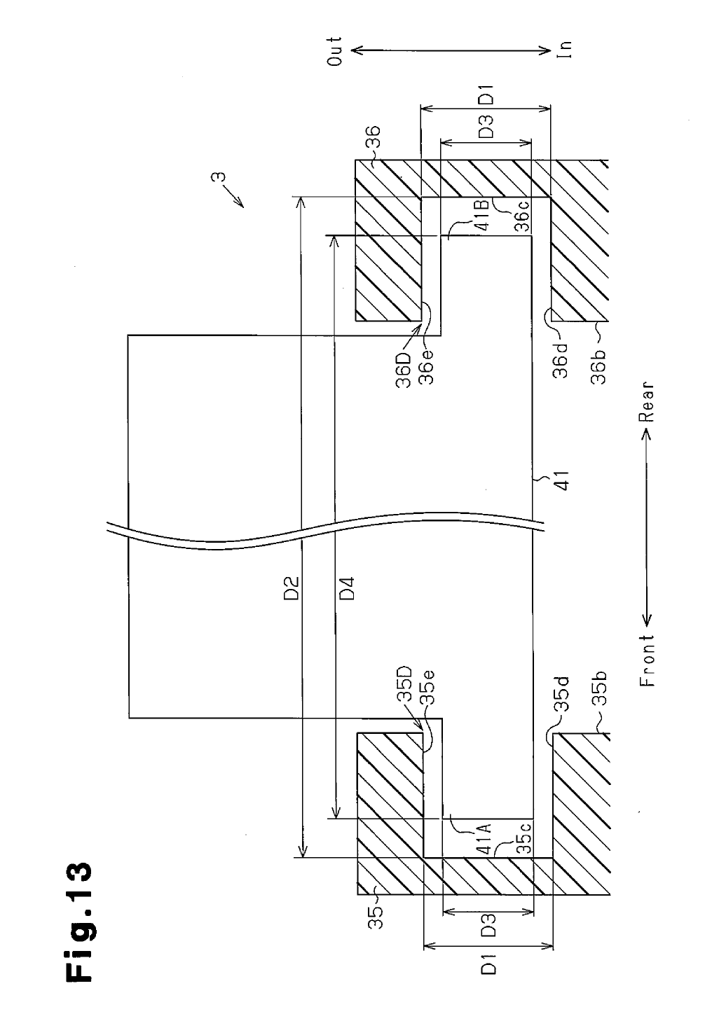

Referring to FIG. 13, dimensions of the flanges 41A and 41B and the grooves 35D and 36D will now be described. In FIG. 13, the direction of the arrows indicating the outward and inward directions is orthogonal to the filtering surface of the air filter 34.

As shown in FIG. 13, in a direction orthogonal to the filtering surface of the air filter 34, the flange 41A has a thickness D3 that is smaller than a width of the groove 35D, or distance D1, between the second and third inner surfaces 35d and 35e. Further, the flange 41B has a thickness D3 that is smaller than a width of the groove 36D, or distance D1, between the second and third inner surfaces 36d and 36e. In the illustrated example, the dimension D3 of the flange 41A is the same as the dimension D3 of the flange 41B. Further, the width D1 of the groove 35D is the same as the width D1 of the groove 36D.

The first inner surface 35c in the groove 35D of the first rack 35 is opposed to the first inner surface 36c in the groove 36D of the second rack 36. The first and second inner surfaces 35c and 36c are separated by distance D2 from each other. The case 41 has a length, namely, dimension D4, between distal ends of the flanges 41A and 41B that is shorter than the distance D2 between the first and second inner surfaces 35c and 36c.

In the present embodiment, the distance D1, dimension D3, distance D2, and dimension D4 satisfy the expression shown below.

(D1−D3)/2<D2−D4)/2

The case 41, which includes the flanges 41A and 41B, are designed to satisfy the above expression. Thus, even when an error occurs in the length D4 of the case 41 when molding the case 41 from resin, the distance from the end of the flange 41A to the first inner surface 35c and the distance from the end of the flange 41B and the first inner surface 36c are easily within allowable limits.

Accordingly, when the flanges 41A and 41B are fitted into the grooves 35D and 36D, the flanges 41A and 41B are supported in a slidable manner by at least one of the inner surfaces in the corresponding grooves 35D and 36D in accordance with the position in which the projector 1 is set.

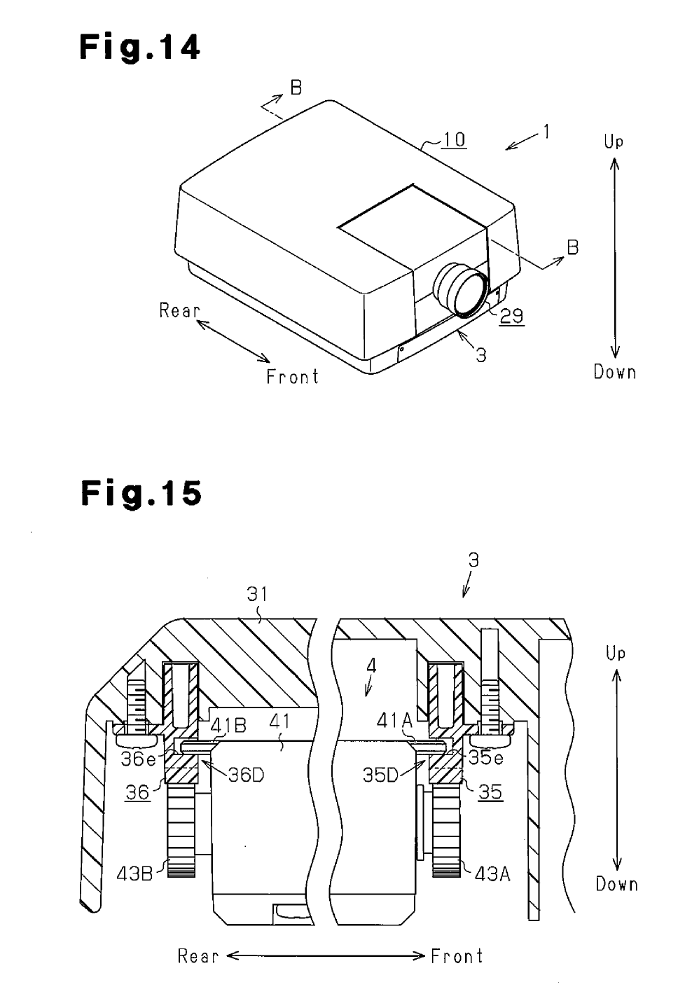

For example, when the projector 1 is arranged on a horizontal surface such as a table as shown in FIG. 14, the flanges 41A and 41B are respectively supported by the third inner surfaces 35e and 36e of the grooves 35D and 36D as shown in FIG. 15.

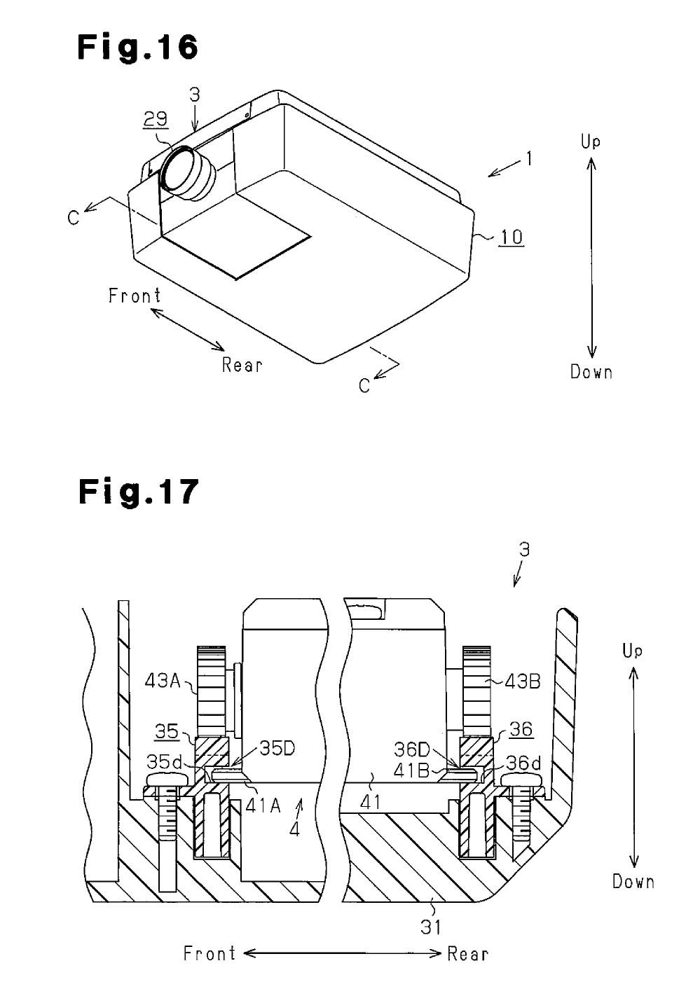

When the projector 1 is arranged on a ceiling as shown in FIG. 16, the flanges 41A and 41B are respectively supported by the second inner surfaces 35d and 36d of the grooves 35D and 36D as shown in FIG. 17.

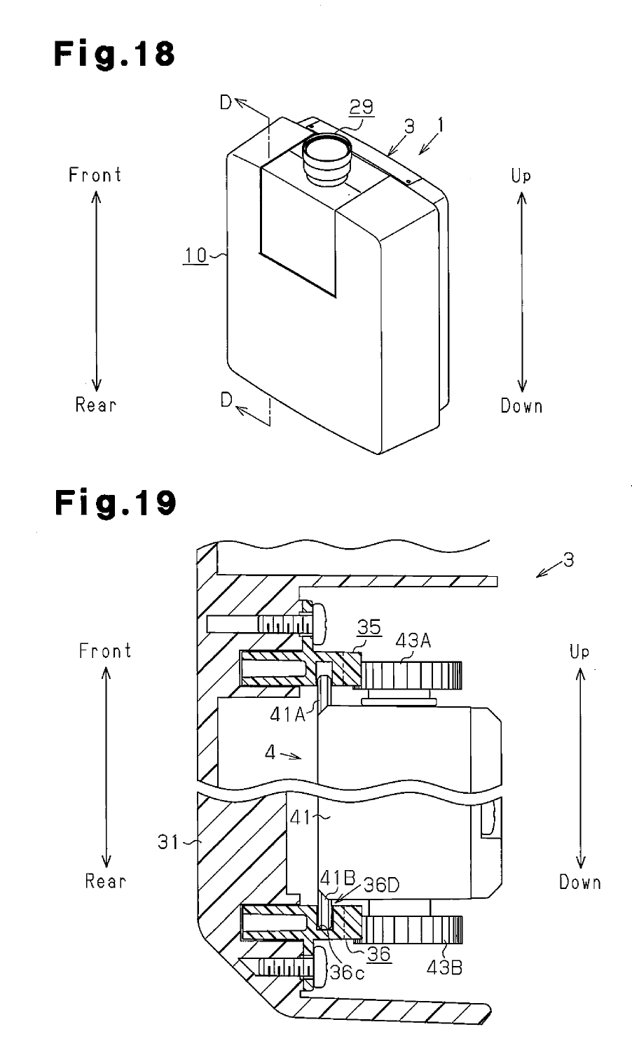

When the projector 1 is arranged on a wall to display an image on a ceiling as shown in FIG. 18, the flange 41B is supported by the first inner surfaces 36c of the groove 36D as shown in FIG. 19.

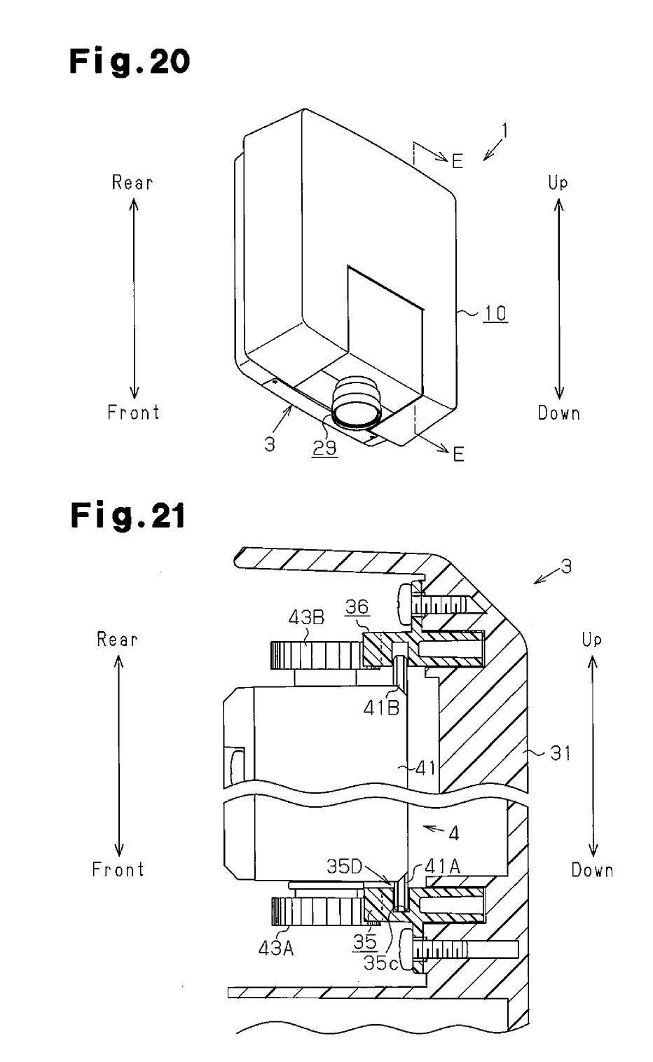

When the projector 1 is arranged on a wall to display an image on a floor as shown in FIG. 20, the flange 41A is supported by the first inner surfaces 35c of the groove 35D as shown in FIG. 21.

In the preferred embodiment, the racks 35 and 36 are formed from polyacetal, which is a resin material that differs from ABS resin, to reduce heat generation, power consumption, frictional noise, and frictional vibration.

The present embodiment has the advantages described below.

(1) The air filter device 3 includes the brush 45, the racks 35 and 36 serving as supports, the pinions 43A and 43B serving as moving mechanisms, and the case 41. The racks 35 and 36 include the side surfaces 35b and 36b that face toward the case 41. The side surfaces 35b and 36b respectively include the grooves 35D and 36D that are arranged along the longitudinal direction of the supports and serve as first engagement portions. The case 41 includes the flanges 41A and 41B serving as second engagement portions. Engagement of the grooves 35D and 36D with the flanges 41A and 41B restrict movement of the case 41 in a direction perpendicular to the longitudinal direction of the supports. In this manner, the grooves 35D and 36D, which are arranged in the longitudinal direction of the supports, support the flanges 41A and 41B. Thus, the case 41 is movable back and forth in the longitudinal direction of the supports without being separated from the racks 35 and 36. The racks 35 and 36 and the case 41 serve as a guide structure that guides the reciprocation of the case 41. The guide structure supports the case 41 at a location separated from where the pinions 43A and 43B are engaged with the racks 35 and 36. This ensures that the case 41, which moves back and forth with the brush 45, is supported regardless of changes in the set position of the air filter device 3 and the projector 1 relative to the gravitational direction.

(2) The racks 35 and 36, which are arranged in the direction in which the brush 45 moves back and forth, and serve as supports. The pinions 43A and 43B, which are engaged with the racks 35 and 36, serve as moving mechanisms. This structure easily obtains the required frictional force between the moving mechanisms and the supports.

(3) The grooves 35D and 36D, which are formed in the side surfaces 35b and 36b of the racks 35 and 36, serve as first engagement portions. The flanges 41A and 41B, which slide in the grooves 35D and 36D formed in the case 41, serve as second engagement portions. Accordingly, a guide structure that guides the reciprocation of the case 41 is formed by a simple structure (mold) that arranges the grooves 35D and 36D in the racks 35 and 36 and arranges the flanges 41A and 41B in the case 41.

(4) The flange 41A is surrounded by the three inner surfaces 35c, 35d, and 35e of the groove 35D. Thus, the flange 41A may be supported from three directions by the single groove 35D.

The flange 41B is surrounded by the three inner surfaces 36c, 36d, and 36e of the groove 36D. Thus, the flange 41B may be supported from three directions by the single groove 36D.

(5) The pinion 43A is a rotating body that rotates to move the case 41. The groove 35D includes the three inner surfaces 35c, 35d, and 35e. The first inner surface 35c is orthogonal to the rotation axis R1 of the pinion 43A. The second inner surface 35d and the third inner surface 35e are parallel to each other and orthogonal to the first inner surface 35c. Thus, the first inner surface 35c restricts movement of the case 41 in a direction parallel to the rotation axis R1 of the pinion 43A. Further, the second inner surface 35d and the third inner surface 35e restricts movement of the case 41 in a direction perpendicular to the rotation axis R1 of the pinion 43A and allows for the case 41 to move only in the reciprocation directions. Accordingly, the first to third inner surfaces 35c, 35d, and 35e support the flange 41A from three directions that are perpendicular to one another.

Further, the pinion 43B is a rotating body that rotates to move the case 41. The groove 36D includes the three inner surfaces 36c, 36d, and 36e. The first inner surface 36c is orthogonal to the rotation axis R2 of the pinion 43B. The second inner surface 36d and the third inner surface 36e are parallel to each other and orthogonal to the first inner surface 36c. Thus, the first to third inner surfaces 36c, 36d, and 36e support the flange 41B from three directions that are perpendicular to one another in the same manner as the first to third inner surfaces 35c, 35d, and 35e.

(6) The second inner surface 35d and third inner surface 35e of the groove 35D face toward each other and are orthogonal to the filtering surface of the air filter 34, which is cleaned by the brush 45. The second inner surface 36d and third inner surface 36e of the groove 36D face toward each other and are orthogonal to the filtering surface of the air filter 34. In a state in which the flanges 41A and 41B are respectively fitted into the grooves 35D and 36D, the interval between the second inner surface 35d or third inner surface 35e of the groove 35D and the flange 41A is smaller than that between the first inner surface 36c of the groove 36D and the flange 41B. The second inner surfaces 35d and 36d of the grooves 35D and 36D restrict movement of the case 41 in a direction orthogonal to the filtering surface of the air filter 34. This stably presses the brush 45, which is arranged in the case 41, against the filtering surface of the air filter 34.

(7) The air filter device 3 includes the first rack 35 and the second rack 36, which are arranged on opposite sides of the air filter. The grooves 35D and 36D are respectively arranged in the side surfaces 35b and 36b of the first and second racks 35 and 36. The case 41 includes the flanges 41A and 41B that respectively engage with the grooves 35D and 36D of the first and second racks 35 and 36. This forms a guide structure that guides the reciprocation of the case 41 with the first rack 35, the second rack 36, and the case 41 and ensures that the case 41 is supported.

(8) The case 41 is formed from ABS resin. The racks 35 and 36 are formed from polyacetal, which has a higher sliding capacity than ABS resin. Thus, in comparison to when the case 41 and the racks 35 and 36 are formed from ABS resin, the sliding capability of the flanges 41A and 41B with respect to the grooves 35D and 36D is increased. The increase in the sliding capability achieves at least one of improvement of the anti-wear capability, reduction of heat generated by the sliding, reduction of power consumption required for the sliding, reduction of frictional noise caused by the sliding, and reduction in the frictional vibration caused by the sliding.

(9) The racks 35 and 36 are formed from polyacetal, which is a resin material having a high sliding capability. This allows for the formation of the grooves 35D and 36D, which have a superior anti-wear capability. Further, polyacetal is an inexpensive resin material.

(10) The projector 1 includes the air filter device 3. Accordingly, the projector 1 obtains the advantages described above.

It should be apparent to those skilled in the art that the present invention may be embodied in many other specific forms without departing from the spirit or scope of the invention. Particularly, it should be understood that the present invention may be embodied in the following forms.

The racks 35 and 36 may be formed from polyamide, a fluorocarbon polymer, polyphenylene sulfide, polyethylene, or polyethylene terephthalate. More specifically, the grooves 35D and 36D obtains a superior anti-wear capability as long as the racks 35 and 36 are formed from a resin material having a high sliding capability, namely, one of polyacetal, polyamide, a fluorocarbon polymer, polyphenylene sulfide, polyethylene, and polyethylene terephthalate. It is preferred that polytetrafluoroethylene be used as the fluorocarbon polymer that has a high sliding capability. Further, it is preferred that ultra high molecular weight high density polyethylene be used as the polyethylene.

The resin material used to form the case 41 is not limited to ABS resin. The material of other components may also be changed as required. For example, components formed from a resin material may be formed from a metal material.

The moving mechanism is not limited to the pinions 43A and 43B as long as the brush 45 and the case 41 can be moved back and forth. Further, the support that supports the moving mechanism is not limited to the racks 35 and 36. For example, the moving mechanism may be a rotating body such as a wheel having a smooth circumferential surface, and the support may be a rail that forms the moving route of the rotating body.

The structure that supports the case 41 with the racks 35 and 36 is not limited to the flanges 41A and 41B and the grooves 35D and 36D. For example, flanges serving as first engagement portions may be arranged on the side surfaces 35b and 36b of the racks 35 and 36, and grooves may be arranged in the case 41 as second engagement portions.

The structure for supporting the front part of the case 41 may differ from the structure for supporting the rear part of the case 41. For example, the structure for supporting the front part of the case 41 may be the flange 41A of the case 41 and the groove 35D of the rack 35, and the structure for supporting the rear part of the case 41 may be a groove (not shown) of the case 41 and a flange, or extension (not shown) of the rack 35.

The air filter device 3 may be arranged on the left side of the projector 1 instead of the right side. Further, the air filter device 3 may be arranged on the rear side of the projector 1 instead of the front side. The direction in which the brush 45 and the dust box 5 move is not limited to the leftward and rightward directions.

The dust box 5 does not have to move together with the brush 45. For example, the dust box may be arranged in an immovable manner at a standby position at which it is separated from the air filter 34. In this case, rotation of the brush 45 at the standby position removes dust from the bristles 45b of the brush 45 and collects the dust in the dust box. In this case, the air filter device preferably includes a first motor, which moves the cleaning unit 4 including the brush 45 and the case 41, and a second motor, which rotates the brush 45 without moving the cleaning unit 4.

The present invention is not limited to a video projector including four light sources. The present invention may also be applied to a video projector including only one light source or at least two light sources. Further, the video projector is not limited to an LCD projector and may be a video projector that uses a digital micromirror device (DMD) to display an image.

The present examples and embodiments are to be considered as illustrative and not restrictive, and the invention is not to be limited to the details given herein, but may be modified within the scope and equivalence of the appended claims.

1. An air filter cleaner comprising:
a brush that cleans an air filter;
a case that moves back and forth together with the brush, which is arranged on the case;
a moving mechanism that moves the brush and the case back and forth, wherein the moving mechanism is arranged on the case;
a support that supports the moving mechanism, wherein the support is arranged along a direction in which the brush moves back and forth, and the support includes a side surface facing toward the case;
a first engagement portion arranged on the side surface of the support, wherein the first engagement portion is arranged along the direction in which the brush moves back and forth; and
a second engagement portion arranged on the case, wherein the second engagement portion engages with and slides relative to the first engagement portion of the support;
wherein the engagement of the first engagement portion and the second engagement portion restricts movement of the case in a direction perpendicular to the direction in which the brush moves back and forth.

2. The air filter cleaner according to claim 1, wherein the support includes a rack, and the moving mechanism includes a pinion that engages with the rack.

3. The air filter cleaner according to claim 1, wherein the first engagement portion is a groove formed in the side surface, and the second engagement portion is an extension fitted into the groove in a slidable manner.

4. The air filter cleaner according to claim 3, wherein the extension is surrounded by three inner surfaces of the groove.

5. The air filter cleaner according to claim 4, wherein
the moving mechanism is a rotating body that rotates about a rotation axis to move the case, and
the three inner surfaces of the groove include a first inner surface, which is orthogonal to the rotation axis, and a second inner surface and third inner surface, which are orthogonal to the first inner surface and parallel to each other.

6. The air filter cleaner according to claim 5, wherein
the second inner surface and the third inner surface are parallel to an air filter surface, which is cleaned by the brush, and
in a state in which the extension is fitted into the groove, an interval between the second or third inner surface and the extension is shorter than that between the first inner surface and the extension.

7. The air filter cleaner according to claim 1, wherein
the support includes a first support and a second support arranged on opposite sides of the air filter,
each of the first and second supports includes a side surface provided with the first engagement portion; and
the case includes a plurality of second engagement portions respectively engaged with the first engagement portions of the first and second supports.

8. The air filter cleaner according to claim 1, wherein
the case is formed from a resin material, and
the support is formed from a resin material having a sliding capability that is higher than that of the resin material forming the case.

9. The air filter cleaner according to claim 1, wherein the support is formed from a resin material having a high sliding capability that is selected from a group consisting of polyacetal, polyamide, a fluorocarbon polymer, polyphenylene sulfide, polyethylene, and polyethylene terephthalate.

10. A video projector comprising the air filter cleaner according to claim 1.

11. An air filter cleaner comprising:
a brush that cleans a filtering surface of an air filter;
a movable case that supports the brush;
a rack extending in a longitudinal direction and including teeth and a first engagement portion;
a pinion arranged on the movable case and engaged with the teeth of the rack, wherein when the pinion is rotated, the movable case and the brush are moved back and forth in the longitudinal direction of the rack;
a second engagement portion arranged on the movable case, wherein when the pinion is rotated, the second engagement portion is moved relative to the first engagement portion of the rack in a state engaged with the first engagement portion, and the second engagement portion of the movable case engages with the first engagement portion of the rack regardless of the orientation of the movable case.

12. The air filter cleaner according to claim 11, wherein
the first engagement portion is a groove extending in the longitudinal direction of the rack and formed in a surface of the rack that differs from a surface on which the teeth are formed, and
the second engagement portion is a flange formed on the movable case and received by the groove of the rack.

13. The air filter cleaner according to claim 12, wherein the flange is surrounded by three inner surfaces of the groove in the rack.

14. The air filter cleaner according to claim 12, wherein the teeth of the rack are arranged between the flange and the pinion.

15. A video projector comprising:
a light source;
an outer case accommodating the light source; and
the air filter cleaner according to claim 1, wherein the air filter cleaner is coupled in a removable manner to the outer case.
